(19) United States
(12) Patent Application Publication
(10) Pub. No.: US 2003/0135398 A1
(43) Pub. Date: Jul. 17, 2003

(54) Method and system for managing commitments, reducing measurement errors, and making safe disclosures

(76) Inventor: Mark Michael Groz, New York, NY (US)

Correspondence Address: MARK M GROZ, 244 Madison Avenue, #377, New York, NY, 10016, US

(21) Appl. No.: 10/001,475

(22) Filed: Nov. 1, 2001

Related U.S. Application Data
(60) Provisional application No. 60/245,044, filed on Nov. 1, 2000.
(60) Provisional application No. 60/245,552, filed on Nov. 3, 2000.
(60) Provisional application No. 60/251,019, filed on Dec. 4, 2000.
(60) Provisional application No. 60/260,548, filed on Jan. 8, 2001.
(60) Provisional application No. 60/260,551, filed on Jan. 8, 2001.

(51) Int. Cl. G06F 17/60

(52) U.S. Cl. 705/7

(57) ABSTRACT

A method and system is disclosed for managing commitments, reducing measurement error, and making safe disclosures. The method and system address the problems of managing commitments, reducing measurement error, and making safe disclosures by providing three inter-related facilities. The first facility is a contingent commitment facility that enables users to formulate and submit sets of contingent commitments and tests those sets for logical consistency and syntactical correctness. The second facility is a valuation facility that enables users to estimate the value of an arbitrary collection of assets, liabilities, or other quantities. The third facility is a negotiation facility that enables two agents to bilaterally negotiate while protecting their negotiation strategy and allowing the agents to form a binding legal contract on the basis of the negotiation.

### CROSS-REFERENCE TO RELATED APPLICATIONS

This application claims benefit of U.S. Provisional Patent Application Nos. 60/245,044, filed Nov. 1, 2000, 60/245,552, filed Nov. 3, 2000, 60/251,019, filed Dec. 4, 2000, 60/260,548, filed Jan. 8, 2001, and 60/260,551, filed Jan. 8, 2001, all of which are hereby incorporated by reference.

### BACKGROUND OF THE INVENTION

Most new ventures fail. A frequently cited reason for this failure is lack of sufficient capital. There is an irony here, because the sources of capital frequently complain that there are too few good opportunities for all the money they have available to invest. This phenomenon applies to a wide range of ventures, from inventors hoping to license their intellectual property rights to entrepreneurs looking for startup capital to operating companies hoping to move in new directions. On the financing side, the difficulty of identifying and getting a piece of the best opportunities is lamented by pension funds, institutional money managers, venture capitalists, “angels”, and other qualified investors. In short, there is a widespread failure on the part of new ventures and sources of capital to find each other in a reasonably efficient way.

Investors, entrepreneurs, and other interested parties must consider many factors when evaluating (from their respective viewpoints) the merits of a private investment opportunity. Though price is perhaps the most obvious factor, many other considerations may be of equal or greater importance. What is the size of the potential market? How will the venture be structured? How (and when) will it make money? How good is the management team? Who is the competition? How high are barriers to entry? Who else is investing? What will the board of directors look like? What is the “exit strategy”?

In consequence of these complexities, many promising opportunities are lost. Successful investors are often inundated with unsolicited opportunities for investing, so that many fine opportunities never even get a hearing. They know this, but are presently unable to increase the scope of their work; they are in constant “bandwidth overload.”

Entrepreneurs also suffer. They must devote inordinate amounts of time to courting sources of finance rather than to the execution of business strategy. This has a potential negative impact on the business under development. It also discourages many capable entrepreneurs from pursuing opportunities. The aggregate cost in lost wealth creation to the global economy can only be guessed at, but it is likely to be tens if not hundreds of billions of dollars.

Potential business deals that involve intellectual property rights raise especially troublesome disclosure issues. Such deals are frequently undermined by the reluctance of a potential licensor to divulge information about trade-secret and/or patent-pending inventions and related IP without the potential licensee, investor, or other counter-party first signing a suitable non-disclosure agreement (“NDA”). Such counter-parties, however, often have valid reasons to avoid signing an NDA: either because of their own IP development efforts, or in the case of investors (e.g., venture capitalists) because they see so much confidential, trade secret, and/or patent-pending material (including business plans, proposed trademarks, and copyrighted material of all sorts) that sooner or later one or more NDAs is sure to lead to litigation. For this reason, many prominent VCs refuse to sign NDAs.

This puts entrepreneurs and inventors in a very difficult position. They must either find counter-parties who are willing to sign NDAs, missing out on the opportunity to work with perhaps the best counterparties in the investment and IP development communities. Or, they can divulge some part of their trade secret and/or patent-pending information, hoping that such unprotected revelations will be treated fairly by all involved, and not damage the value of their IP.

As can be seen from the previous examples, there are many situations in life where making a contingent commitment to perform an action and/or to disclose information is difficult or impossible. This unfortunate situation forces a wide variety of people, whether they are acting, for example, as buyers, sellers, donors, recipients, employers, or employees to resort to unconditional commitments or to simplified contingent commitments that leave key conditions out of the equation. The term “agents” will be used herein to designate such individuals, or any other individuals who may have a need to manage their commitments and make safe disclosures.

Furthermore, in a wide variety of contexts, the costs associated with being first to show his or her hand can be sufficiently onerous to significantly slow or even stop desirable things from occurring. Such contexts include: financial transactions, legal negotiations, philanthropic decision-making, central-bank policy making, governmental and/or inter-governmental policy-making, internal corporate strategic planning, joint venture negotiations, venture capital investing, intellectual property development, scheduling of meetings, other events and processes, early adoption of new products and services, and other socially useful group activities.

### BRIEF SUMMARY OF THE INVENTION

The present invention addresses the problems of managing commitments and making safe disclosures by providing three inter-related facilities, each of which addresses a different facet of the problem.

A contingent commitment facility that enables users to formulate and submit sets of contingent commitments and tests those sets for logical consistency and syntactical correctness. Validated sets of different users are combined to discover outcomes that satisfy pre-defined objectives and constraints, while offering user-specifiable privacy protection before, during, and after the conclusion of group interaction.

A valuation facility that enables users to estimate the value of an arbitrary collection of assets, liabilities, other quantities.

A negotiation facility that enables two agents to bilaterally negotiate while protecting their negotiation strategy and allowing the agents to form a binding legal contract on the basis of the negotiation.

As used herein, the term “contingent commitments,” means statements of the form:

[1] “Agent A will perform action B under a set of conditions C”;

[2] “Agent A* will disclose data D under a set of conditions C*”;

[3] Statements logically equivalent to [1] or [2];

[4] Compound statements consisting of atomic statements of the form [1],[2], and/or [3], connected by logical predicates, quantifiers, and/or modal operators.

It should be noted that, if a set of conditions is either the empty set or always satisfied, then a contingent commitment based on that set is indistinguishable from an ordinary (unconditional) commitment to do something. By the above definition, ordinary unconditional commitments are a subset of the larger set of conditional commitments. This is intended, as is the ability of the method and system for managing contingent commitments to manage ordinary, unconditional commitments.

### BRIEF DESCRIPTION OF THE DRAWINGS

The above summary of the invention will be better understood when taken in conjunction with the following detailed description and accompanying drawings in which:

FIG. 1 is a block diagram of an architecture suitable for implementing the present method and system;

FIG. 2 is a flow chart of a preferred embodiment of the operation and use of the contingent commitment module;

FIG. 3 is a flow chart of a preferred embodiment of the operation and use of the valuation module;

FIG. 4 is a flow chart of a preferred embodiment of the operation and use of the negotiation module; and

FIG. 5 is a flow chart of an alternative preferred embodiment of the operation and use of the negotiation module.

### DETAILED DESCRIPTION OF THE PREFERRED EMBODIMENT

The present method and system increase the ability of agents to manage their commitments and to make safe disclosures of sensitive information. It comprises three, independently useful and mutually complementary components for contingent commitment, valuation, and negotiation.

The Contingent Commitment Module facilitates the managing of contingent commitments. This module speeds up the process by which multiple independent agents may formulate strategy and reach agreements with each other. These agreements may be binding, non-binding, or subject to future events.

The Valuation Module facilitates the valuation of an arbitrary collection of assets, liabilities, or other quantities.

The Negotiation Module facilitates automated bilateral negotiation, while offering privacy protection to both parties before, during, and after the negotiation.

Each of the above mechanisms may be used singly or in combination with the others to facilitate commitment management and safe disclosure among agents. In a preferred embodiment, they are implemented as part of a secure, interactive, online network, e.g., a virtual private network accessible via an internet protocol. This allows for real-time valuation, real-time bilateral negotiation, and real-time contingent commitments-all significantly expediting the deal-making process while lowering costs.

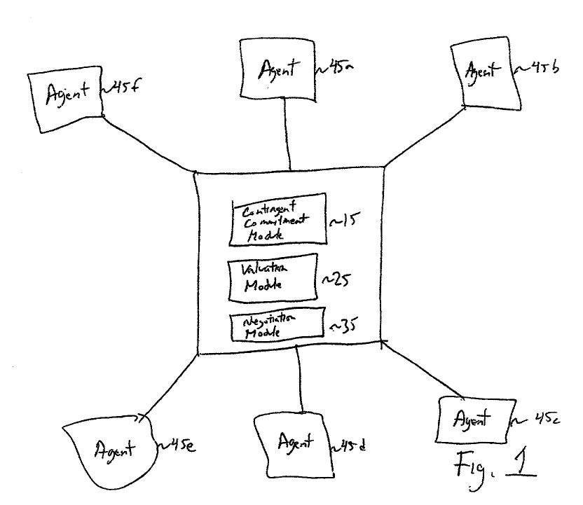

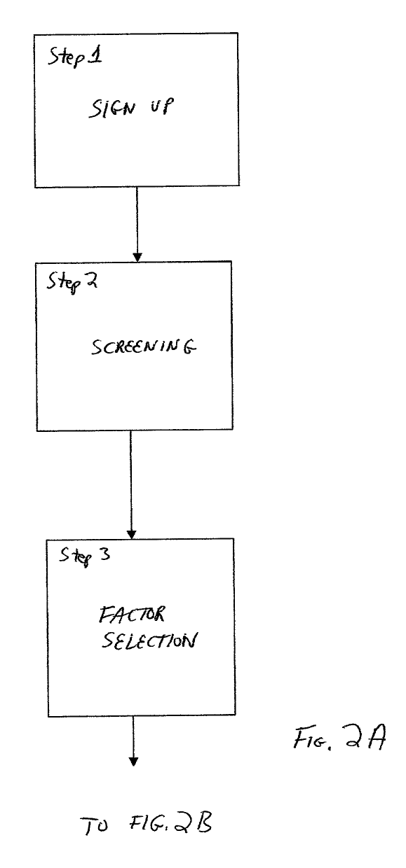

A suitable architecture for implementing the present method and system is shown in FIG. 1. As shown in FIG. 1, the architecture comprises a contingent commitment module 15, a valuation module 25, and a negotiation module 35. A plurality of agents 45 preferably communicate with these modules via appropriate networks and/or other communications means as described above.

Contingent Commitment Module

This module provides users with a facility for making contingent commitments of capital and/or other resources, and for transforming such multiple contingent commitments into “done deals.” In one embodiment, the module may implement the method described below; however, other tools may also be made available, as well as the capability of a user to use tools of their preference.

One of the greatest impediments to deal making is the need to coordinate decision-making amongst multiple parties. This module allows deal participants to commit their resources on a contingent basis-i.e., subject to other conditions which may include one or more of the following:

Who else is in on the deal

Management Team

Board Composition

Strategic partners

Pricing of the deal

Terms of later rounds of financing

IP Licenses

Exit Strategy

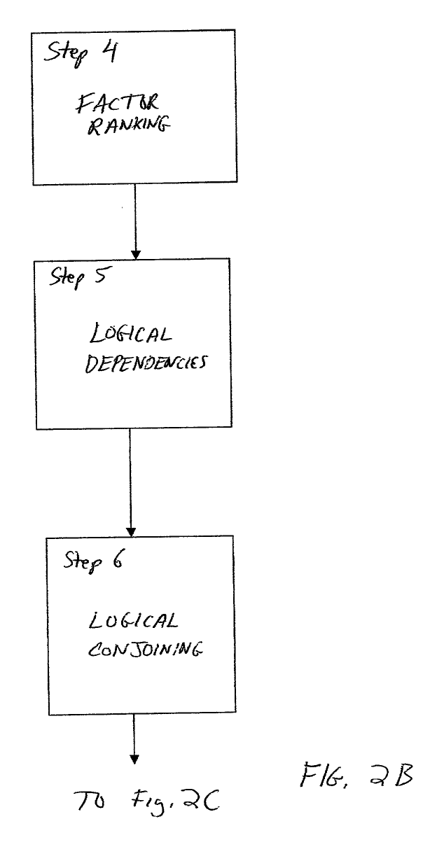

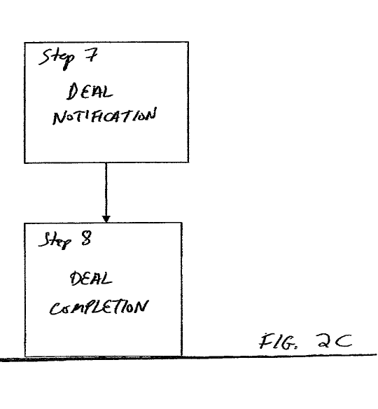

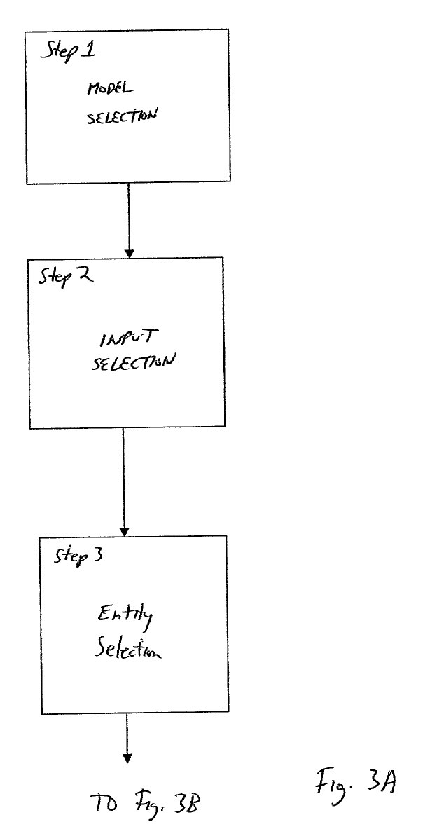

A preferred embodiment for operation and use of contingent commitment module 15 is now described in connection with FIG. 2.

As shown in FIG. 2, in step 1, one or more agents signs up to use the contingent commitment module for one or more problems as part of a problem solving group.

In step 2, the agents are screened and a database storing information about agents updated, according to a set of default minimum qualifying criteria established by the contingent commitment module, along with additional criteria that may be supplied by one or more of the agents. This can be as simple as providing a list of parties who may be eligible to enroll as agents, or may involve efforts to notify potential interested and qualified agents.

In step 3, each agent enrolled in a problem-solving group deal may make contingent commitments by selecting (e.g., by clicking boxes on a template) problem-related factors that are important to said agent. An agent may use a privacy filter to mask any of these factors so that no other agent knows that the factor has been selected by that agent. An agent may also partially mask any of these factors so that only specified other agents may see that it has been selected. Note that an agent may remain anonymous to all other agents, or may choose to reveal various degrees of identifying information to selected agents.

In step 4, each agent in a problem-solving group may rank the factors in order of importance. These rankings are converted into default percentage weights with the sum of all rankings equal to 100%. Alternatively, agents may assign percentage weights directly. As in step 3, an agent may mask or partially mask any of the rankings associated with a factor. For purposes of this ranking, no one factor is assumed to be a “deal-killer” for any agent.

In step 5, each agent indicates logical dependencies between factors (e.g. A and B; B or C; if C then not D; etc.) This is where agents express their “must haves” and their “deal killers”.

In step 6, the logical dependencies specified in (3) are conjoined to discover the space of all possible solutions to the problem. The conjunction engine, preferably implemented as a part of the contingent commitment module, looks for all possible solutions involving one or more agents. This engine produces two types of solutions. absolute solutions and contingent solutions. “Absolute solutions” as herein defined are solutions all of whose conditions are satisfied. “Contingent solutions” as herein defined are solutions one or more of whose conditions are not presently satisfied or are not presently known to be satisfied. Said solutions may include: solutions that automatically becoming binding; solutions that are non-binding and may be pursued off-line; solutions that are subject to an online vote with pre-defined voting rules which may include plurality, simple majority, super-majority, or unanimous; and solutions that are subject to future contingencies.

In step 7, agents are notified of the solutions that have been calculated, with as much information as permitted by the masks adopted by said agents. Each solution will have a value associated with it, equal to the sum of all factors included in said solution for each user included in said solution. For example, say that 3 agents are included in a solution: A, B, and C. Say that the sum of included factors for agents A, B, and C are 80%, 50%, and 30%, respectively. The value associated with this solution is 160%.

In step 8, the problem is completed. In a preferred embodiment, the problem may be completed and a binding commitment arrived at in one of two ways:

Automatic Mode: if all agents agree in advance, the absolute solution with the highest associated value is made into a binding commitment (subject to usual due diligence and closing conditions, and any applicable laws.)

Manual Mode: each agent in the problem solving group may vote for one or more of the absolute solutions in which it is included; the first solution to satisfy the voting rules of the problem solving group is made into a binding commitment (subject to usual due diligence and closing conditions, and any applicable laws).

If a problem is not completed, agents may return to step 1 to try again. Agents may also set preferences regarding additional problem-solving rounds, in which they may make conditional commitments to engage in said rounds. These conditional commitments may be based on a standardized set of conditions that may be selected from a template and/or agent-defined conditions that may be submitted to the contingent commitment module.

Contingent solutions may be carried over into said rounds and may become absolute solutions if the conditions that were not satisfied in earlier rounds become satisfied. In a preferred embodiment, additional features may be added to the above-described flow. For example:

If no agent objects, an agent may allocate part of his 100% factor allocation to the (negative) value of being left out of the deal. This would lower the value of any solution in which that agent was not involved, at the expense of lowering that agents ability to shape the structure of a solution in other ways.

If no agent objects, an agent may commit up to 100% of his factor weightings to another agent.

Agents may submit information about one or more accounts for payments related to problem-solving group participation and/or transactions arising from solutions. Forms of payment may include: credit card, debit card, Paypal™, c2it™, checking account transfer, or other electronic funds transfer. Express authorizations may be received from appropriate authority such as credit card issuer, debit card issuer, bank, or other electronic funds transfer system sponsor, to charge said accounts.

Valuation Module

The valuation module provides agents with the ability to improve the accuracy with which they estimate the value of assets (e.g., intellectual property), liabilities, and other quantifiable entities or collections of entities which may be involved in a potential transaction. In a preferred embodiment, the valuation module may implement a particular model (referred to herein as the internal model) in performing such valuation; however, other valuation models may be used in conjunction with the present method and system, as well as the capability of a user to use a valuation model of their preference.

The valuation module provides an effective means to estimate a range of fair values for a collection of assets, liabilities, other entities, or collections of entities (A/L/E/C). The valuation module also may provide a single best estimate for the value of the A/L/E/C to a particular enterprise, organization, organizational unit, individual, or group. The module uses one or more individuals (“value assessors”) who use or create (optionally probability-weighted) valuation models. In a preferred embodiment, at least two (and preferably more) value assessors are used to reduce the error in the estimates. A/L/E/C is valued with reference to a specific actual or potential owner, or stakeholder, or with respect to a set of such actual or potential owners or other stakeholders. The ability to estimate the value of A/L/E/C to an enterprise is of great potential commercial value. It can be used in any application where the value of some A/L/E/C needs to be objectively estimated.

In a preferred embodiment, the valuation module utilizes an effect known as error cancellation. Error cancellation is a mathematical and statistical phenomenon that arises when a series of unbiased estimates with unknown random errors are used together in a calculation. The resulting calculation benefits from the tendency of random errors to cancel each other out, leading to a result with less uncertainty than in any single step of the calculation. Instead of “Garbage In, Garbage Out”, the result of a series of random errors can be a highly accurate measurement.

Error cancellation is independent of any particular valuation model; thus the present method can be applied to any existing valuation model, as well as to any valuation model that may be invented in the future. The valuation module employs multi-dimensional error cancellation, enabling agents to enhance the effect of error cancellation by increasing its dimensionality.

As known in the art, the effect of error cancellation in its simplest form operates automatically whenever multiple independent inputs are estimated by an individual using a model. Enrico Fermi, for example, is said to have used a series of estimates to calculate the yield of the first atomic bomb, with a result that was within a few percentage points of a subsequent computer calculation.

The present method improves on such one-dimensional error cancellation by requiring at least one additional dimension of error cancellation. This additional dimension may be any of the following:

A plurality of sets of inputs;

A plurality of value assessors;

A plurality of models; or

A plurality of entities relative to which the valuation is performed.

If it is desired to extend the model, additional dimensions may be defined by any of the following: a value assessor, a model, or an entity relative to which the valuation is performed.

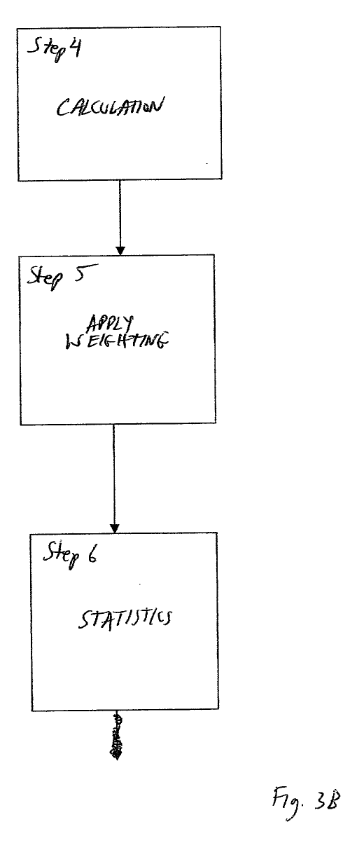

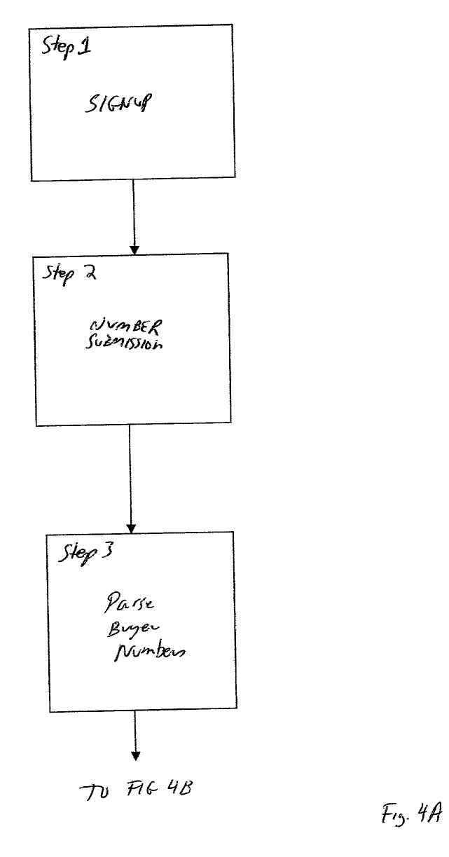

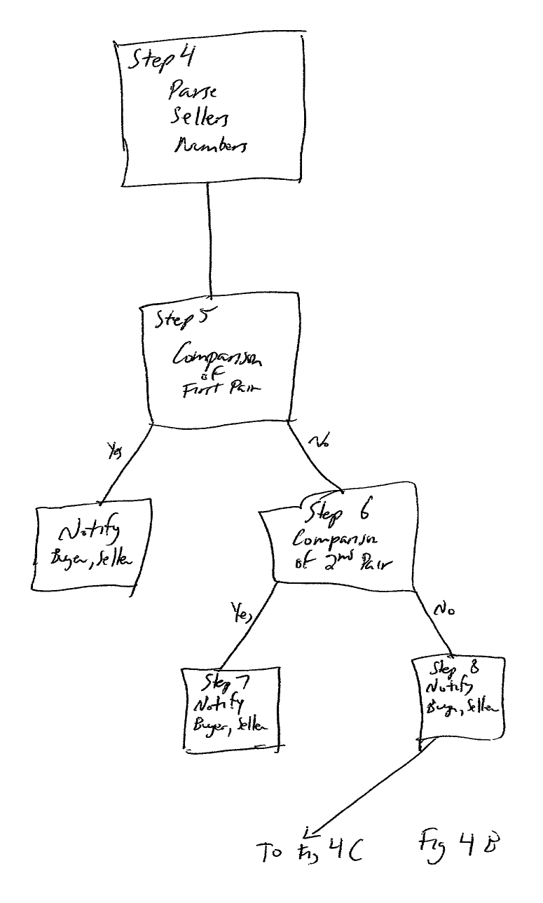

A preferred embodiment for operation and use of the valuation module 25 is now described in connection with FIG. 3. As shown in FIG. 3, in step 1, each value assessor selects one or more models and decides on weighting factors for each of the models to be used for valuation.

In step 2, each value assessor selects one or more sets of inputs and decides on weighting factors for each of the sets of inputs used by each model.

In step 3, each value assessor selects one or more entities and decides on weighting factors for each of the entities for which the valuation is performed

In step 4, each value assessor performs one or more calculations using the models, input sets, and entities chosen in steps 1, 2, and 3.

In step 5, each value assessor does a weighted average across models, input sets, and entities, using the weights chosen in steps 1, 2, and 3.

In step 6, the median, mean, mode, and standard deviation are calculated from the results obtained by each value assessor in step 5.

For example, assuming there are four value assessors estimating the value of some A/L/E/C to five different entities. This would give rise to five A/L/E/C valuation equations (one for each entity). Each equation uses a measure of central tendency (preferably the median value) of the value assessors estimates of each input to reduce error.

If desired, value assessors may optionally create multiple probability-weighted scenarios instead of a single set of estimates.

In a preferred embodiment, a value assessor may, but need not, use the following internal model, in which case (s)he creates projections of costs and/or revenue, changes in costs and/or revenue, and losses and/or profits arising from the A/L/E/C being valued. If desired, these projections may be probability weighted.

### EXAMPLE

### Non-Probability Weighted A/L/E/C Valuation Equation for a Single Entity, Using Internal Model

Internal Model Required Inputs:

1. Estimated size of total relevant market at two or more points in time.

2. For each point in time in (1), estimated percentage of total relevant market for which the A/L/E/C has an economic impact (“A/L/E/C relevant submarket”).

3. For each enterprise, individual, or group for whom the value of the A/L/E/C is being estimated, estimated market share of gross costs/revenues of “A/L/E/C relevant submarket” at each point in time.

4. For each gross cost/revenue estimate in (3), estimated percent that can be considered net cost/revenue.

5. For each net cost/revenue estimate in (4), estimated margin.

6. Estimate terminal value factor(at latest point in time).

7. Apply a hurdle rate or similar discount factor (supplied by enterprise or other entity, or estimated by value assessor) to get estimated present value.

$$MVAL [ t , {t}_{1} , … , {t}_{n} , E , h ] = {PVF}_{t} \{ [ TRM ( {t}_{1} , … , {t}_{n} ) \times IRM ( {t}_{1} , … , {t}_{n} ) \times ICM ( {t}_{1} , … , {t}_{n} ) \times NR ( {t}_{1} , … , {t}_{n} ) \times MAR ( {t}_{1} , … , {t}_{n} ) ] + [ NETPER ( {t}_{n} ) ] \}$$

Where

MVAL[t,t₁, . . . ,tₙ,E,h] is Value of A/L/E/C at time t for Entity E, with hurdle rate h, and estimates at t₁, . . . ,tₙ

PVFₜ is a time value of money function, accumulating and/or discounting all values to time t at an estimated risk adjusted hurdle rate or at a rate stipulated by the entity for which value is being calculated.

TRM (t₁, . . . ,tₙ) is Median Estimated size of total relevant market at each of 2 or more times {t₁, . . . ,tₙ}

IRM (t₁, . . . ,tₙ) is Median Estimated % of total relevant market at each of 2 or more times {t₁, . . . ,tₙ} for which the A/L/E/C provides an economic impact

ICM (t₁, . . . ,tₙ) is Median Estimated % market share (at each of 2 or more times {t₁, . . . ,tₙ} resulting from entity's use of A/L/E/C

NR(t₁, . . . ,tₙ) is Median Estimated % of that market share (at each of 2 or more times {t₁, . . . ,tₙ} that can be considered net cost/revenue

MAR is (t₁, . . . ,tₙ) Median Estimated % of that margin at each of 2or more times {t₁, . . . ,tₙ}

NETPER(tₙ) is Median Estimated Net Cost/Revenues at tₙ×Terminal Value Factor at tₙ.

### EXAMPLE

### Estimate the Present Value of IP to Entity E Using the Following Estimates:

Hurdle Rate=100%

TRM={$500,000,000,000 today, $560,000,000,000 in 3 years}

IRM={5%, 25%}

ICM={0%, 10%}

NR={0%,5%}

MAR={0%,20%}

Terminal Value Factor=20

NETPER={$560,000,000,000×25%×10%×5%×20%}×20=$140,000,000×20=$2,800,000,000,

MVAL=PVF[0 today;$140,000,000+$2,800,000,000 in 3 years, discounted back three years at 100% growth rate]=$2,940,000,000×(0.5×0.5×0.5)=$367,500,000

Negotiation Module

Often, when two trading parties are drawn together, it is difficult and costly to determine a fair (or even a mutually acceptable) price. This is especially true for products and services for which no significant market exists, and for unique products and services that may have little or no relevant points of comparison. In these cases, each trader may be reluctant to “make the first move.” If one has a distinct advantage in bargaining power over the other, he can usually demand that the other make an offer. However, many times it is not clear who should “go first.” As a result, an unknown but probably very large number of transactions never happens, simply because neither party is willing to bear the risk of “showing his cards” first.

The negotiation module addresses this problem by providing a neutral mechanism through which each party is able to safely disclose the price at which (s)he would like to complete the transaction and also the limit price (a maximum for buyers, a minimum for sellers) beyond which they are unwilling to complete the transaction. The negotiation module further facilitates bilateral trade by providing a secure messaging facility that enables the parties to communicate supplemental information during the trading process, including information about willingness to trade under various conditions.

Another problem, addressed by an optional extension of the negotiation module is that sometimes the buyer wants to or can only pay in units of value that are not acceptable to the seller but may be readily acceptable to others.

The negotiation module, addresses these problems by:

Making it safe for both sides to reveal pricing information to a secure, neutral intermediary mechanism

Making it possible for both sides to communicate securely with each other before, during, and after revealing pricing information to the intermediary mechanism

Making it possible for both sides to choose their preferred units of value

If possible, automatically finding a price that satisfies both trading parties

Helping the trading parties to find a mutually satisfactory price even if their initial positions do not generate a transaction.

From a systems perspective, the negotiation module preferably comprises a user interface module (“UIM”) and an information processing module (“IPM”). Analytically, the negotiation module preferably combines a deterministic algorithm (“APN_{DA}”) with realtime human override capabilities (“APN_{RO}”).

The combination of APN_{DA} with APN_{RO} provides a powerful means for two trading parties to automatically determine the price for a collection of goods and/or services being sought by one trader (“buyer”) and offered for sale by another (“seller”) while reserving the ability to override this automatic mechanism with specific proposals and communications.

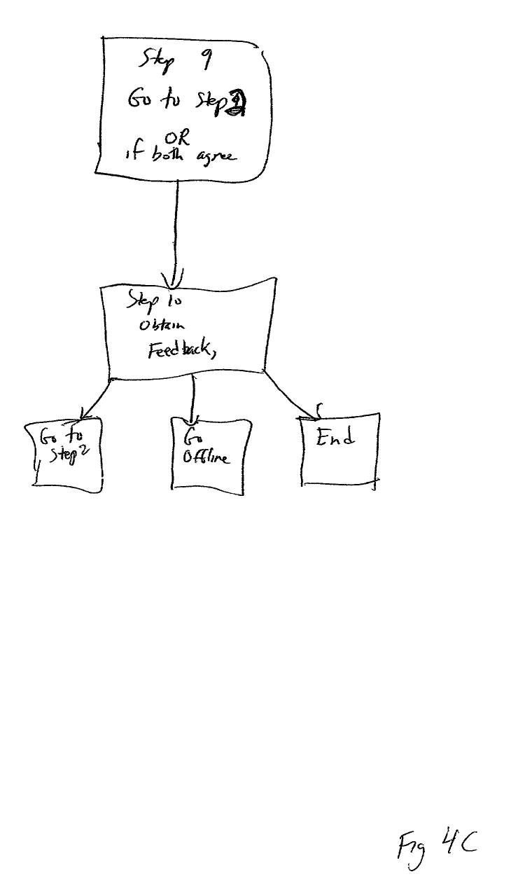

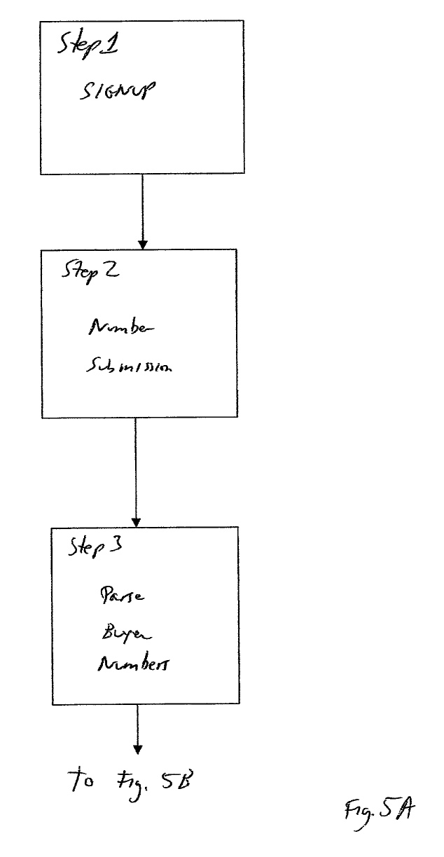

A preferred embodiment for implementing APN_{DA} is now described in connection with FIG. 4. As shown in FIG. 4, in step 1, a buyer and a seller agree to use the negotiation module. This agreement may be facilitated by a computer, which may receive one or more requests from one or more agents to negotiate with one or more other agents. The computer may notify one or more agents of an opportunity to negotiate with one or more other agents.

In step 2, buyer and seller each submit two numbers to the negotiation module. Neither is allowed to see the other's numbers.

In step 3, buyer's numbers are his “favored price”, (expressed in dollars or other pre-determined unit of value) and his “flexibility factor” (expressed either as a percentage of the favored price, or as an incremental number of units above the favored price buyer would be willing to pay.)

In step 4, seller's numbers are his “favored price”, (expressed in dollars or other pre-determined unit of value) and his “flexibility factor” (expressed either as a percentage of the favored price, or as an incremental number of units below the favored price seller would be willing to accept.)

In step 5, favored prices of buyer and seller are compared. If the favored price of buyer is greater than or equal to the favored price of seller, then the transaction price is set at the midpoint of the favored prices.

In step 6, if the favored price of buyer is less than the favored price of seller, then each favored price is modified either by multiplying by its correspondent flexibility factor, or by adding or subtracting the incremental number of units for buyers or sellers respectively. The resulting numbers are referred to as the “outer limit” price of buyer and seller respectively.

In step 7, if the outer limit price of the buyer is greater than or equal to the outer limit price of the seller, then the transaction price is set at the midpoint of the outer limit prices.

In step 8, if the outer limit price of the buyer is less than the outer limit price of the seller, then the system notifies buyer and seller that they did not generate an automatic match.

In step 9, buyer and seller have the option of trying again, by resubmitting their favored price and flexibility factor (with or without changes).

In step 10, alternatively, if buyer and seller agree, the negotiation module will inform them of one or more of the following: the midpoint between their outer limit prices, the midpoint of their favored prices, or the midpoint of all four prices. Buyer and seller can agree in advance to transact at one of these midpoints, can go back to step (2), negotiate offline, or cease negotiating.

### EXAMPLES

1. Buyer B wants to buy item I from Seller S. B submits his favored price of 1500 dollars, with a flexibility factor of 20%. Seller submits his favored price of 1000 dollars, with a flexibility increment of 0 dollars. Because B's favored price is greater than S's favored price, the negotiation module generates a transaction price of $1250, the midpoint of the favored prices.

2. Buyer B wants to buy item I from Seller S. B submits his favored price of 1500 dollars, with a flexibility factor of 20%. Seller submits his favored price of 1800 dollars, with a flexibility increment of 0 dollars. Because B's favored price is less than S's favored price, the negotiation module applies the flexibility calculations to each, generating the “outer limit” prices. B's outer limit price is $1500+($1500×20%)=$1800. S's outer limit price is the same as his favored price, $1800. Since the two outer limit prices match, the negotiation module generates a transaction price of $1800.

3. Buyer B wants to buy item I from Seller S. B submits his favored price of 1500 dollars, with a flexibility factor of 20%. Seller submits his favored price of 2000 dollars, with a flexibility factor of 10%. In this case, once again, the negotiation module must generate “outer limit” prices, and once again, they both equal $1800.

4. Buyer B wants to buy item I from Seller S. B submits his favored price of 1500 dollars, with a flexibility factor of 10%. Seller submits his favored price of 2000 dollars, with a flexibility factor of 10%. In this case, once again, the negotiation module must generate “outer limit” prices; this time, however, B's outer limit price is only $1650. Therefore no automatic price is generated. The negotiation module informs B and S that there is no transaction and gives them the option of trying again, or of “opening the envelope” to see how far apart they are. If they choose to open the envelope, they may decide in advance to accept the midpoint of their outer limit prices; this would generate a transaction at $1725. They could also choose to accept the midpoint of their favored prices ($1750) or of all four prices ($1737.50).

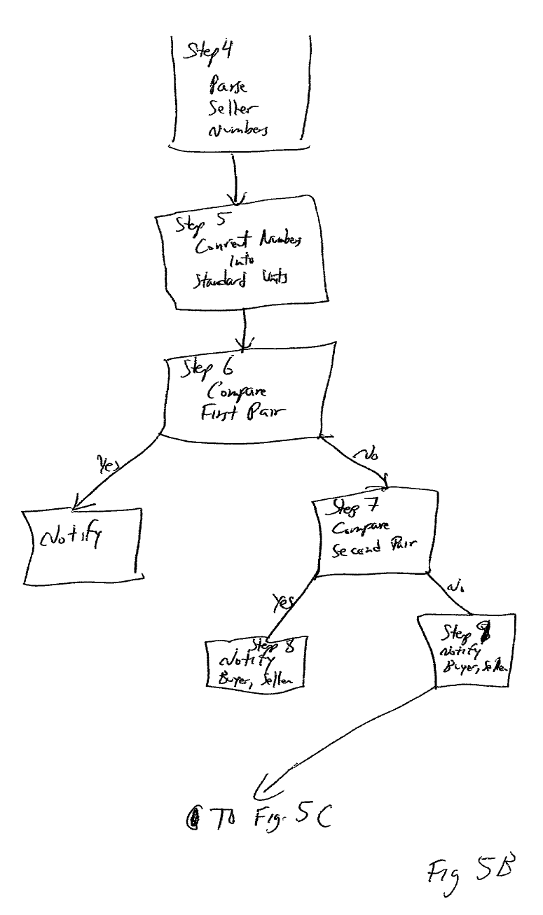

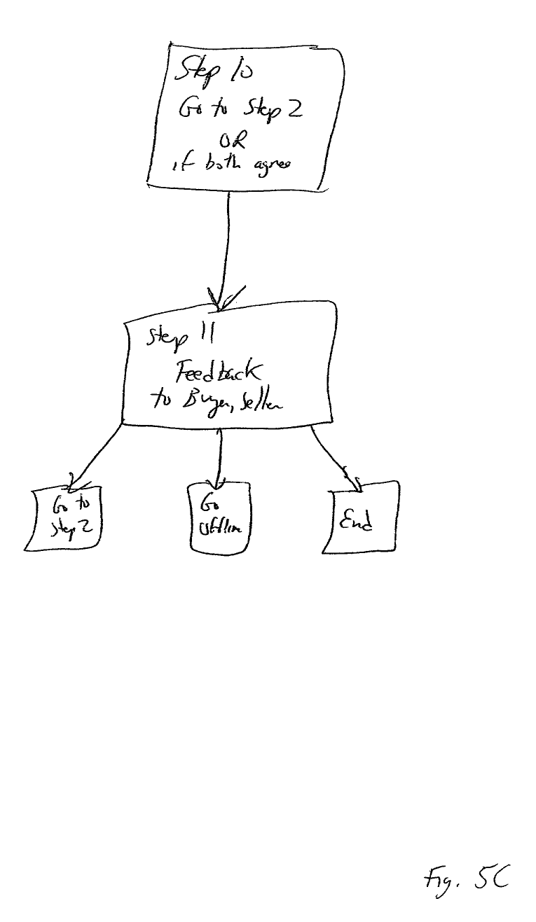

An alternative preferred embodiment for implementing APN_{DA} is now described in connection with FIG. 5. As shown in FIG. 5, in step 1, A buyer and a seller agree to use the negotiation module.

In step 2, buyer and seller each submit two numbers to the negotiation module. Neither is allowed to see the other's numbers.

In step 3, Buyer's numbers are his “favored price”, (expressed in any unit of value allowed by the negotiation module) and his “flexibility factor” (expressed either as a percentage of the favored price, or as an incremental number of units above the favored price buyer would be willing to pay.)

In step 4, Seller's numbers are his “favored price”, (expressed in any unit of value allowed by the negotiation module) and his “flexibility factor” (expressed either as a percentage of the favored price, or as an incremental number of units below the favored price seller would be willing to accept.)

In step 5, Buyer and seller's numbers are converted into comparable units by the negotiation module. If such conversion is not possible, the negotiation module notifies buyer and seller and asks each to submit a list of alternative units of value, in order of preference. The negotiation module chooses the unit of value with the highest combined preference rating, if such unit exists. If no such unit exists, the negotiation module notifies buyer and seller, giving them the option to try again

In step 6, Once a unit of value has been determined, favored prices of buyer and seller are compared. If the favored price of buyer is greater than or equal to the favored price of seller, then the transaction price is set at the midpoint of the favored prices.

In step 7, If the favored price of buyer is less than the favored price of seller, then each favored price is modified either by multiplying by its correspondent flexibility factor, or by adding or subtracting the incremental number of units for buyers or sellers respectively. The resulting numbers are referred to as the “outer limit” price of buyer and seller respectively.

In step 8, If the outer limit price of the buyer is greater than or equal to the outer limit price of the seller, then the transaction price is set at the midpoint of the outer limit prices.

In step 9, If the outer limit price of the buyer is less than the outer limit price of the seller, then the system notifies buyer and seller that they did not generate an automatic match.

In step 10, Buyer and seller have the option of trying again, by resubmitting their favored price and flexibility factor (with or without changes). This process of “iterative resubmission” can also be automated by either party.

In step 11, Alternatively, if buyer and seller agree, the negotiation module will inform them of one or more of the following: the midpoint between their outer limit prices, the midpoint of their favored prices, or the midpoint of all four prices. Buyer and seller can agree in advance to transact at one of these midpoints, can go back to step (2), negotiate offline, or cease negotiating.

### EXAMPLE

Buyer B wants to buy item I from Seller S. B submits his favored price of 100 shares of stock in IJK Corp., with a flexibility factor of 20%. Seller submits his favored price of 1000 dollars, with a flexibility increment of 0 dollars. The negotiation module converts B's pricing into dollars at an “exchange rate” of $10/share. Because B's favored price, as converted, is equal to S's favored price, the negotiation module generates a transaction price of $1,000. The negotiation module accepts payment from B in B's units and delivers payment to S in S's units.

In a preferred embodiment, the embodiments described above may be extended using the following options.

1. Serial Weights Option.

Users may opt to assign serial weights to successive rounds of the algorithm. If both users elect to apply serial weights in their negotiations, an additional field, called the current round weighting (“CRW”), becomes available for data entry on the UIM.

Users each enter a number between 0 and 100 for CRW. These numbers are used as scaling factors to adjust the negotiated price between the parties for that round alone (a round consists of calculations with favored prices, and contingent on the outcome of that calculation, a second calculation with the flexibility factors included).

The CRW amount entered by a party in a given round is deducted from the amount available to that party in subsequent rounds, if any. Thus a party has the option to spend most of his 100 CRW points early, or to save most of them for later rounds.

To see how this works let's return to the first example of APN_{DA}. In example 1 buyer has specified a favored price of 1500 with a flexibility factor of 20%, and seller has specified a favored price of 1000 with a flexibility increment of zero. Without the serial weight feature, APN_{DA} generates a price of 1250 as the result. Let's say, however, that buyer and seller have agreed to use serial weights in their negotiating. Buyer, who has a favored price of 1500, inputs a weight of 100. Seller, who has a favored price of 1000, inputs a weight of 25. The result is scaled as a ratio of the weights entered, giving an outcome of $1400, i.e., a number that is closer to the buyer's favored price in proportion to the ratio of the buyer's and seller's CRWs.

In this example, the buyer benefited from entering the highest possible CRW. If, however, no deal had closed, the seller would have an advantage in subsequent rounds. If serial weighting is selected, no information about the counter-party's choices in earlier rounds is provided. Thus, use of serial weights is one way for traders to put a cloak over the exact values of their strategy, even after the deal is done. In the example above, the fact that the deal was completed at $1400 does not let either party infer the exact nature of his/her counterparty's favored price. The CRW effectively “cloaks” this price from reverse engineering after the fact This can be important to traders who deal regularly with each other, and want to prevent the counterparty from understanding the nature of their strategizing. The possibility that the counterparty is entering a random CRW is enough to ensure that no certain conclusion may be drawn about his favored price or his flexibility factor.

2. Paired Serial Weights Option.

Users may opt to assign pairs of serial weights to successive rounds of the algorithm. If both users elect to apply paired serial weights in their negotiations, two additional fields, called current round weighting-primary (“CRW-P”) and current round weighting-secondary (“CRW-S”), become available for data entry on the UIM. These function exactly as above, except that users can now set individual current round weightings for their favored price and for their flexibility factor.

Users each enter a number between 0 and 100 for CRW-P and CRW-S. CRW-P numbers are used as scaling factors to adjust the negotiated price between the parties for the first calculation in round, the one that uses favored prices alone. CRW-S numbers are used to scale the result of the second calculation in a round, where favored prices are adjusted by flexibility factors.

The CRW amounts entered by a party in a given round are deducted from the amounts available to that party in subsequent rounds, if any. Thus a party has the option to spend most of his 100 CRW-P and/or CRW-S points early, or to save most of either or both of these for later rounds.

APN_{RO} lets traders feel out the other side with purely informational messages, requests, and/or offers, any or all of which may reveal part of the trading intent of each side. When a party sends a message, the APN_{DA} is suspended according to logic stipulated in that message. Options include: suspension until counterparty responds; suspension for fixed time period; suspension until specific event occurs; or some combination of the above. A purely informational message, called an “fyi” message, will only suspend the APN_{DA}. A transactional message, which may be either a “bid” or an “ask” message, can terminate the APN_{DA} if its conditions are agreed to by the other side. One important example of a bid message is a “sell now price” to the potential seller. This reveals to the seller a price at which the bidder will consummate the transaction right now. The bidder may stipulate a time window for this sell now price, or may wait for the response of the counterparty, or may condition his/her bid on some other event (such as completion of another transaction with another counterparty using the negotiation module).

The negotiation module may be implemented in many ways, including, but not limited to:

A web-based application service accessible by browser. Authorized users may conduct business by submitting their respective favored and flexibility numbers for specific transactions. Users can be notified of transaction outcomes when logging onto the site, or via email, fax, or other messaging facility, or by a person.

A telephone-based application service accessible by telephone. Touch-tone, voice-activated, or analogous method for data entry. Users can be notified of transaction outcomes by voice-messaging, email, or other messaging facility, or by a person.

A set of smart-cards or similar devices with the algorithm embedded into it. These could be used in conjunction with either of the above, optionally storing default prices and automatic negotiating “strategies” for unattended multiple round negotiations.

A set of telephones (fixed, cellular, or two-way radio) with the algorithm embedded into it, operating analogously to the smart-cards mentioned above.

It should be recognized that although the preferred embodiments above are described primarily in terms of a buyer and a seller negotiating a price, the parties to the negotiation, and the nature of the quantity being negotiated, may instead be different depending on the context. For example, in a negotiation between governments about the setting of a geographical boundary, the parties may be two sovereign governments and the quantity may be a numeric representation of a set of geographic coordinates corresponding to a boundary line.

The negotiation module disclosed herein may also be used in other applications such as salary negotiations, Employers may have little idea of what a prospective employee is willing to accept; likewise, employees may have little understanding of how much to ask for. Neither side wants to offend the other. Employers do not want to overpay; job seekers do not want to accept less than they are worth. The negotiation module can help both “buyer” and “seller” to feel more confident that the deal they strike is a reasonable, unbiased result.

Another important application is to online marketplaces, whether they are business to business marketplaces, (“B2B”), business to consumer marketplaces (“B2C”), consumer to consumer marketplaces (“C2C”) or variants or analogs thereof In all these cases, bilateral price negotiations and communications, if possible at all, can be complex, costly, and difficult. Traditional fixed-price transactions are biased in the way they distribute information between buyers and sellers. A fixed price mechanism, while simple to operate, provides the least flexibility and information to the potential traders—whether the price is set by the seller, or offered as a “take it or leave it” price by the buyer.

While the invention has been described in conjunction with specific embodiments, it is evident that numerous alternatives, modifications, and variations will be apparent to those skilled in the art in light of the foregoing description.

I claim

1. A method for using a computer to solve problems involving a plurality of agents, comprising:
receiving by said computer a request to participate in a new or existing problem-solving group;
submitting an update to a database storing information about agents, contingent commitments, and rules for processing said commitments to discover potential solutions;
sending an update notification to agents in the problem-solving group according to agent-definable criteria, said notification comprising:
an indication that a new agent has joined the problem-solving group; a description of solutions, if any, discovered by processing of the contingent commitments according to the rules of the database, with an indication of solution type, for each such solution;
information about said agent; and
information about one or more contingent commitments of said agent.

2. The method of claim 1, wherein information about said agent is controlled by privacy filters that can be removed only by said agent.

3. The method of claim 1, wherein information about one or more contingent commitments of said agent is controlled by privacy filters that can be removed only by said agent.

4. The method of claim 1, wherein said solutions may be of the following types: binding, non-binding, subject to vote, subject to future contingencies.

5. The method of claim 1 wherein said request includes at least one contingent commitment relating to the problem.

6. The method of claim 1 wherein one of said solutions may be converted into a binding agreement among the agents or a subset of the agents.

7. The method of claim 1 further comprising:
receiving an identifier specifying form of payment and account information to be used in providing payments related to problem solving group participation and/or transactions arising from solutions.

8. The method of claim 7 wherein the form of payment includes at least one of the following: credit card, debit card, Paypal™, c2it™, checking account transfer, or other electronic funds transfer.

9. The method of claim 7 further comprising:
receiving an express authorization to charge said account for said problem solving group participation.

10. The method of claim 9 wherein said express authorization is received from one of the following: a credit card issuer, a debit card issuer, a bank, or other electronic funds transfer system sponsor.

11. The method of claim I wherein said problem includes at least one of:
a negotiation among a plurality of parties concerning the price of a collection of goods and/or services;
a negotiation among a plurality of parties concerning a scalar value, other than price,
relating to a collection of goods and/or services;
a negotiation among a plurality of parties relating to venture capital investing;
a negotiation among a plurality of parties relating to a joint venture undertaking;
a negotiation among a plurality of parties relating to the development of intellectual property;
a negotiation among a plurality of parties relating to internal corporate strategic planning;
a negotiation among a plurality of parties concerning the scheduling of one or more meetings, events, or processes;
a negotiation among a plurality of parties concerning the early adoption of new products and/or services;
a negotiation among a plurality of parties concerning terms of settlement of a legal dispute;
a negotiation among a plurality of parties concerning disposition of funds for charitable purposes;
a negotiation among a plurality of parties concerning conduct of central bank policy;
a negotiation among a plurality of parties concerning governmental or inter-governmental policy-making; and
a negotiation among a plurality of parties relating to group activities

12. A system for processing contingent commitments, comprising:
a means for receiving a request to participate in a new or existing problem-solving group;
a means for submitting an update to a database storing information about agents,
contingent commitments, and rules for processing said commitments to discover potential solutions;
a means for sending an update notification to agents in a problem-solving group according to agent-definable criteria, said notification comprising:
an indication that a new agent has joined the problem-solving group;
a description of solutions, if any, discovered by processing of the contingent commitments according to the rules of the database, with an indication of solution type, for each such solution;
information about said agent; and
information about said agent's contingent commitments.

13. A method for improving the accuracy of a valuation estimate, pertaining to one or more assets and/or liabilities, said method comprising:
performing one or more calculations at the request of one or more agents to estimate the value of a quantity, said calculations comprising:
said agents selecting one or more models;
said agents deciding on model weighting factors for each of the models to be used for valuation;
said agents selecting one or more sets of inputs;
said agents deciding on input weighting factors for each of the sets of inputs used by each model;
said agents selecting one or more entities;
said agents deciding on entity weighting factors for each of the entities for which the valuation is performed;
said agents performing one or more calculations using said models, said model weighting factors, said input sets, said input set weighting factors, said entities, and said entity weighting factors;
said agents calculating weighted averages for each of across said models, said input sets,
and said entities, using said model weighting factors, said input set weighting factors, and
said entity weighting factors; and
calculating the median, mean, mode, and standard deviation of said weighted averages.

14. A method for using a computer to conduct a negotiation between two agents, said negotiation comprising:
receiving by said computer a request from an agent to negotiate with another agent;
notifying an agent by said computer of an opportunity to negotiate with another agent;
receiving by said computer data related to a negotiation between two agents;
performing a calculation to determine whether the negotiation produces a value acceptable to said agents;
notifying said agents of the outcome of a negotiation;
facilitating real-time communication between agents before, during, and after the negotiation session.

15. The method of claim 14, wherein the subject of said negotiation is a price or other scalar quantity associated with a collection of goods, services, or other assets and/or liabilities, whether tangible or intangible.

16. The method of claim 14, wherein one of said agents is a buyer and a second of said agents is a seller.

17. A method for using a computer to manage commitments and make safe disclosures, comprising:
receiving by said computer a request to participate in a new or existing problem solving group;
submitting an update to a database storing information about agents, contingent commitments, and rules for processing said commitments to discover potential solutions;
sending an update notification to agents in the problem-solving group according to agent-definable criteria, said notification comprising:
an indication that a new agent has joined the problem-solving group;
a description of solutions, if any, discovered by processing of the contingent commitments according to the rules of the database, with an indication of solution type, for each such solution;
information about said agent; and
information about one or more contingent commitments of said agent;
performing one or more calculations at the request of one or more agents to estimate the value of a quantity, said calculations comprising
said agents selecting one or more models;
said agents deciding on model weighting factors for each of the models to be used for valuation;
said agents selecting one or more sets of inputs;
said agents deciding on input weighting factors for each of the sets of inputs used by each model;
said agents selecting one or more entities;
said agents deciding on entity weighting factors for each of the entities for which the valuation is performed;
said agents performing one or more calculations using said models, said model weighting factors, said input sets, said input set weighting factors, said entities, and said entity weighting factors;
said agents calculating weighted averages for each of across said models, said input sets,
and said entities, using said model weighting factors, said input set weighting factors, and said entity weighting factors; and
calculating the median, mean, mode, and standard deviation of said weighted averages;
conducting a negotiation between two agents, said negotiation comprising:
receiving by said computer a request from an agent to negotiate with another agent;
notifying an agent by said computer of an opportunity to negotiate with another agent,
receiving by said computer data related to a negotiation between two agents;
performing a calculation to determine whether the negotiation produces a value acceptable to said agents;
notifying said agents of the outcome of a negotiation; and facilitating real-time communication between agents before, during, and after the negotiation session.

18. The method of claim 17, wherein said calculations are facilitated by one or more computers.
